(19) United States
(12) Patent Application Publication
(10) Pub. No.: US 2026/0113469 A1
(43) Pub. Date: Apr. 23, 2026

(54) NEURAL-NETWORK BASED ARCHITECTURE FOR FEATURE REDUCTION AND RESTORATION

(71) Applicant: InterDigital VC Holdings, Inc., Wilmington, DE (US)

(72) Inventors: Fabien Racape, San Francisco, CA (US); Ian Harshbarger, Corona, CA (US); Hyomin Choi, Sunnyvale, CA (US); Syed Mateen Ul haq, Mountain View, CA (US)

(21) Appl. No.: 18/918,455

(22) Filed: Oct. 17, 2024

(51) Int. Cl. H04N 19/33; H04N 19/172; H04N 19/70

(52) U.S. Cl. CPC H04N 19/33; H04N 19/172; H04N 19/70

(57) ABSTRACT

An encoding method is disclosed. A plurality of feature tensors is obtained that comprises at least a first feature tensor having a first spatial resolution and a second feature tensor having a second spatial resolution, wherein the second spatial resolution is higher than the first spatial resolution. The plurality of feature tensors is reduced into a two-dimensional frame of feature data. Reducing comprises fusing the plurality of feature tensors into a final latent tensor from the first spatial resolution toward the second spatial resolution and further converting the final latent tensor into the 2D frame of feature data. The 2D frame of feature data is encoded in a bitstream.

### BACKGROUND

The present application is related to machine learning technologies for vision applications.

### BRIEF SUMMARY

Briefly stated, in one embodiment an encoding method is disclosed. A plurality of feature tensors may be obtained that comprises at least a first feature tensor having a first spatial resolution and a second feature tensor having a second spatial resolution, wherein the second spatial resolution is higher than the first spatial resolution. The plurality of feature tensors may be reduced into a two-dimensional frame of feature data. Reducing may comprise fusing the plurality of feature tensors into a final latent tensor from the first spatial resolution toward the second spatial resolution and further converting the final latent tensor into the 2D frame of feature data. The 2D frame of feature data may be encoded in a bitstream.

Briefly stated, in one embodiment, a decoding method is also disclosed. A two-dimensional frame (2D frame) of feature data may be obtained from a bitstream. The plurality of feature tensors may be restored based on the 2D frame of feature data. The plurality of feature tensors may comprise at least a first feature tensor having a first spatial resolution and a second feature tensor having a second spatial resolution, wherein the second spatial resolution is higher than the first spatial resolution. An operation may be performed using the restored plurality of feature tensors. Restoring may comprise converting the 2D frame of feature data into a latent tensor at the second spatial resolution and further reconstructing the plurality of feature tensors based on the latent tensor from the second spatial resolution toward the first spatial resolution. Corresponding encoding and decoding apparatuses are also disclosed.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a block diagram illustrating an example system according to one or more embodiments of the present disclosure;

FIG. 2 is a block diagram illustrating an example video encoder according to one or more embodiments of the present disclosure;

FIG. 3 is a block diagram illustrating an example video decoder according to one or more embodiments of the present disclosure;

FIG. 4 is a block diagram illustrating an example of split computing; and

FIG. 5 is a block diagram illustrating an example of feature data decomposition in a feature compression scheme;

FIG. 6 is a block diagram illustrating an example of Region-based Convolutional Neural Network (RCNN);

FIG. 7 is a block diagram illustrating an example of a neural network architecture for feature reduction;

FIG. 8 is a diagram illustrating an example of tiling channels of a feature tensor into a packed feature tensor;

FIG. 9 is an example of packed feature tensors onto a monochrome video frame;

FIG. 10 is a block diagram illustrating an example of a training and inference pipeline;

FIG. 11 is a block diagram illustrating an example of an architecture of a learned image compression based on an auto-encoder structure augmented with a hyperprior model of the distributions of the latent variables;

FIG. 12 is a block diagram illustrating an example of a codec proxy;

FIG. 13 is a block diagram illustrating another example of a training and inference pipeline;

FIG. 14 is a block diagram illustrating another example of a codec proxy;

FIGS. 15A and 15B shows examples of packed feature tensors onto a monochrome frame;

FIG. 16 is a block diagram illustrating an example of an encoding method;

FIG. 17 is a block diagram illustrating an example of a decoding method;

FIG. 18 is a block diagram illustrating an example of a reduction and restoration architecture;

FIGS. 19 and 20 are block diagrams illustrating various blocks of the reduction and restoration architecture;

FIG. 21 is a block diagram illustrating an example of a mixing block of the reduction and restoration architecture; and

FIG. 22 shows another example of 2D feature frame.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

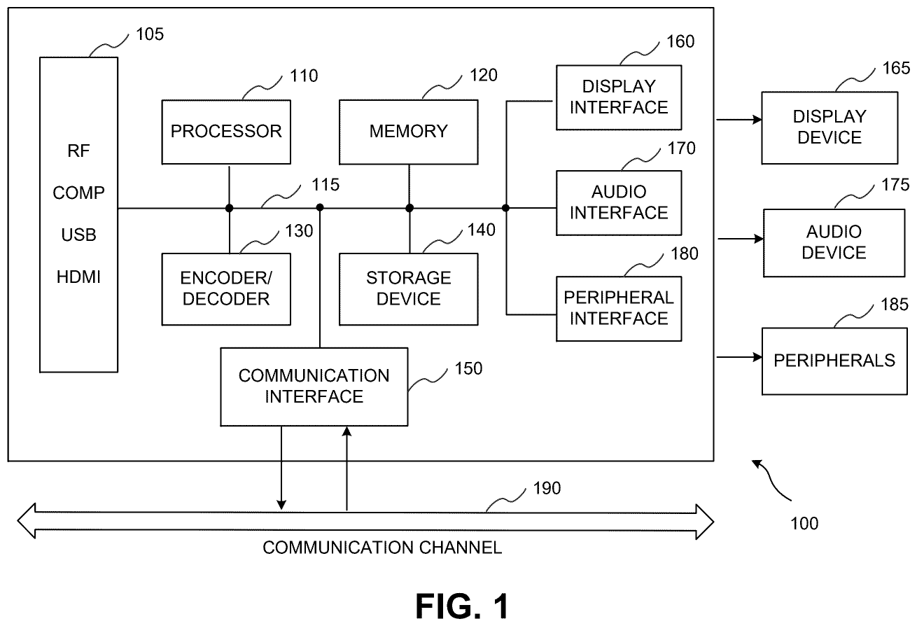

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., I2C bus), wiring, and printed circuit boards.

The system 100 includes at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 includes at least one memory 120, for example, a volatile memory device and/or a non-volatile memory device. The system 100 includes a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 includes an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 is used to store instructions and/or provide working memory for video encoding and decoding functions. In some embodiments, memory external to the processor 110 and/or the encoder/decoder module 130 (e.g., the memory 120 and/or the storage device 140) is used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 includes a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

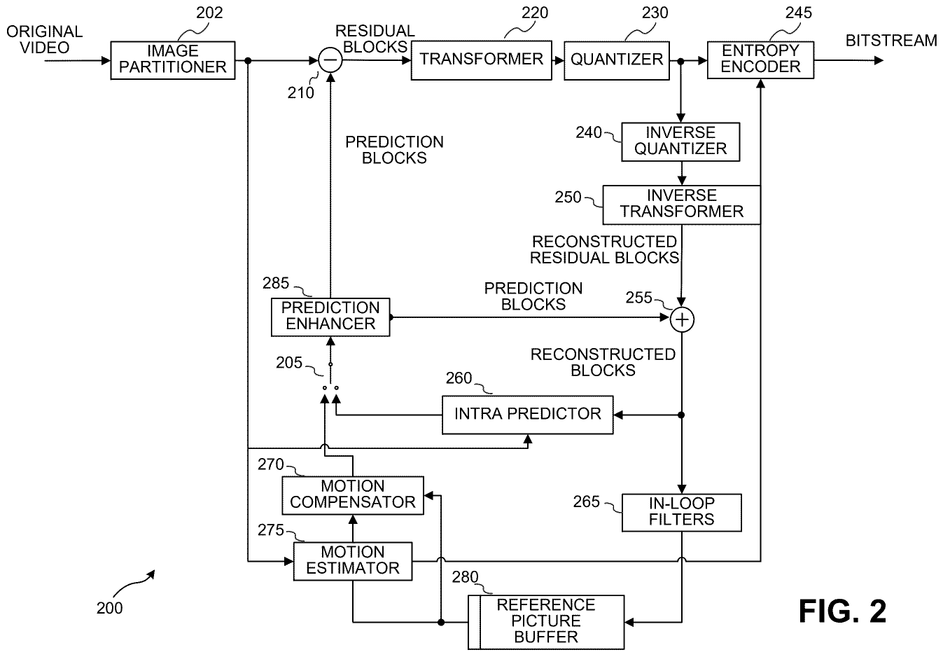

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

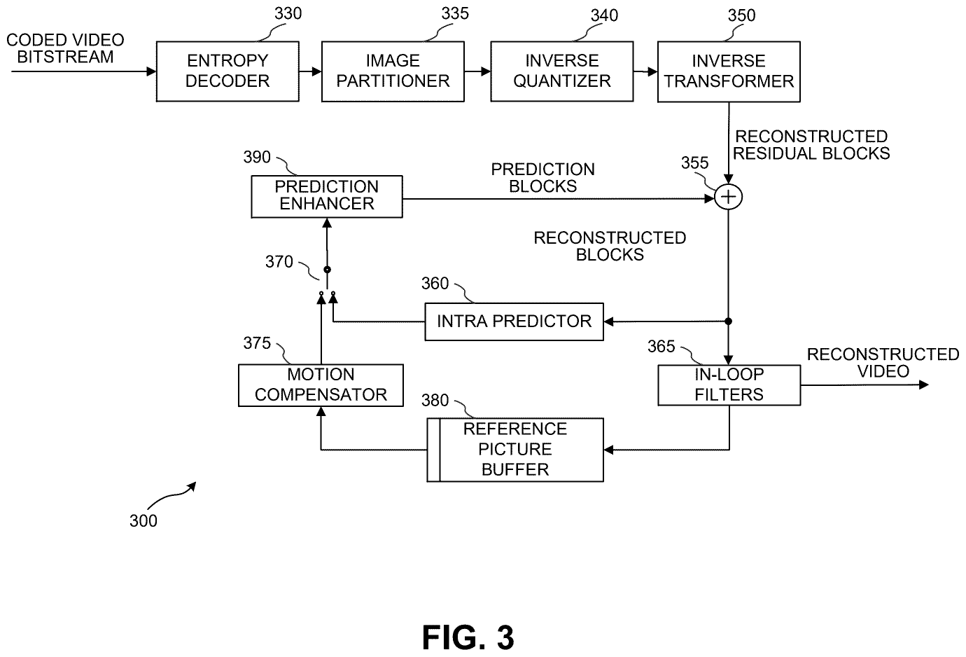

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU includes a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (i.e., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (reconstruct) respective residual blocks. Depending on the selected prediction mode, a predicted block can be obtained at 370 from an intra predictor 360 (i.e., intra prediction) or from a motion compensator 375 (i.e., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

Examples may be described herein in the context of collaborative intelligence (e.g., remote or shared analysis of source images or videos by deep neural networks (DNNs) that may perform computer vision tasks such as classification, object detection, object tracking, etc.). Those skilled in the art will appreciate, however, that the examples may also be applicable in other contexts or use cases.

With the rise of machine learning technologies for vision applications (e.g., intelligent transportations, smart cities, intelligent content management, etc.), the amount of video and image contents consumed by machines (e.g., in comparison to human video and image consumption) may increase. Vision tasks may involve heavy computations and may be performed on cloud systems (e.g., rather than on devices that may be used to capture source contents). Video contents may be transmitted to the cloud systems. The video contents (e.g., source data) may be compressed to fit physical bandwidths and/or storage capacities.

Conventional image and video processing methods such as a standard video codec may be suitable for human image or video consumption but may not be efficient for machine vision based on systems or applications (e.g., machine vision may not be sensitive to the same artifacts produced by lossy compression).

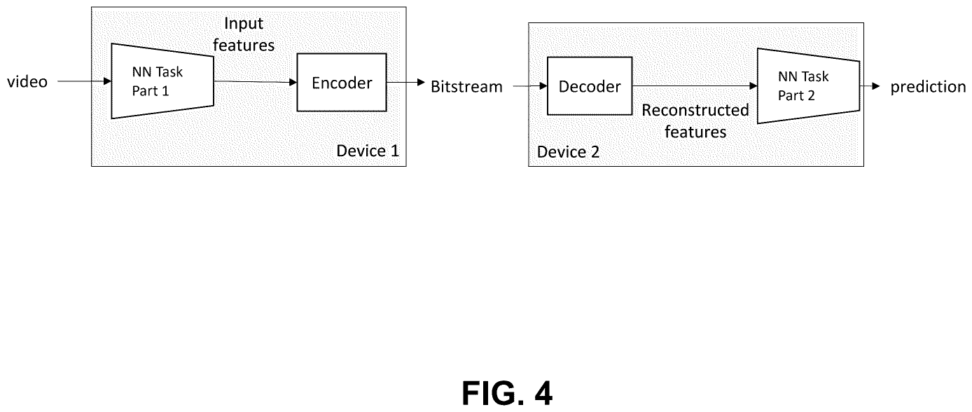

An example way for enabling efficient remote analyses may include compressing source videos using methods that may be optimized for downstream vision tasks (e.g., rather than for human visual systems). An example of a framework used to perform such remote analysis is illustrated by FIG. 4.

FIG. 4 illustrates an example of split computing in which the inference or the computation of a neural network (NN) may be shared between multiple devices (e.g., two remote devices). As shown in FIG. 4, an output of a first part (e.g., NN task part 1) of a split NN on device 1 may include features extracted by the NN (e.g., which may be referred to herein as intermediate data at a split point, a.k.a. intermediate feature at a split point) and/or may be transmitted to a Device 2 (e.g., a remote Device 2). In examples, the intermediate data may be encoded into a compressed bitstream, e.g., using a video encoding device and/or a video encoder. Device 2 (e.g., including a video decoding device and/or a video decoder) may receive and decode the transmitted intermediate data, e.g., to perform a second part of the network (e.g., NN Task Part 2), e.g., to perform a target vision task. In an example, the decoded intermediate data (a.k.a. reconstructed features) may be outputted to a second part of the split NN (e.g., NN task part 2). The latter outputs the final predictions, e.g., bounding box coordinate and associated object class (car, dog, person, etc.) in the case of object detection. The features, or the intermediate data, are tailored for the target vision task(s) and compressed in bitstreams smaller than the original video data to be transmitted over the network. This approach saves on bandwidth compared to video coding for machine scheme but incurs a slightly higher energy cost by running part of the split AI model at the sensor device. In examples, device 1 may correspond to a battery-operated camera or a phone and device 2 may correspond to a remote cloud server. In examples, such split inference strategy may be used to offload some of the computations if the device (e.g., the battery-operated camera) that captures and/or stores source contents (e.g., videos) is limited in terms of processing power, memory, and/or energy (e.g., battery power). It may also be useful to transmit features while protecting the privacy of the original contents since the original pixels may not be directly coded.

The examples provided herein may describe one split point (e.g., an NN being divided into two parts), but the techniques described in those examples may also be used to split an NN into more than two parts (e.g., with more than one split point) and/or among multiple (e.g., more than two) devices. In examples, adequate video data, such as bitstreams of intermediate data, may be created for one or more split points (e.g., at each split point).

When used herein, the term “video” may include image and/or video contents. Further, while video may be used as an example input to a neural network (e.g., NN task part 1 as shown in FIG. 4) in the examples provided herein, the neural network technology described herein may be used to process any type of input (e.g., audio, text, medical imaging, etc.).

Different techniques may be used to compress intermediate data (e.g., data at a split point of a neural network). These techniques may include, for example, transforming the intermediate data into an array (e.g., a two-dimensional (2D) array) and applying image and/or video coding/decoding techniques (e.g., signal prediction, transforms, quantization, re-sampling, entropy coding, etc.) to the array of data, for example, to reduce the size of a bitstream. For example, video encoder 200 may be used. In the case of split model performed on video content, the tensors of intermediate data may represent a single input video frame and may be transformed into a 2D array. Temporal sub-sampling may be applied so that intermediate data may be transmitted for one frame out of two.

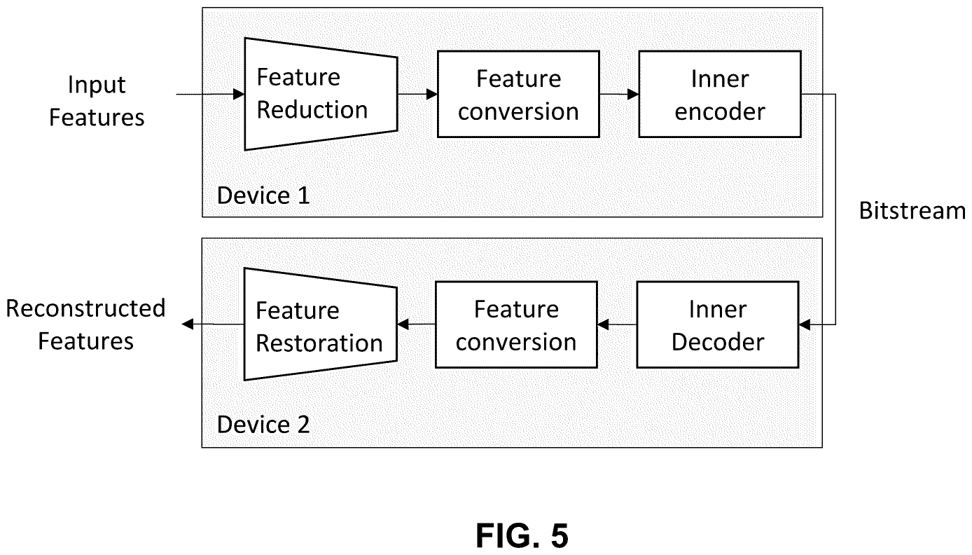

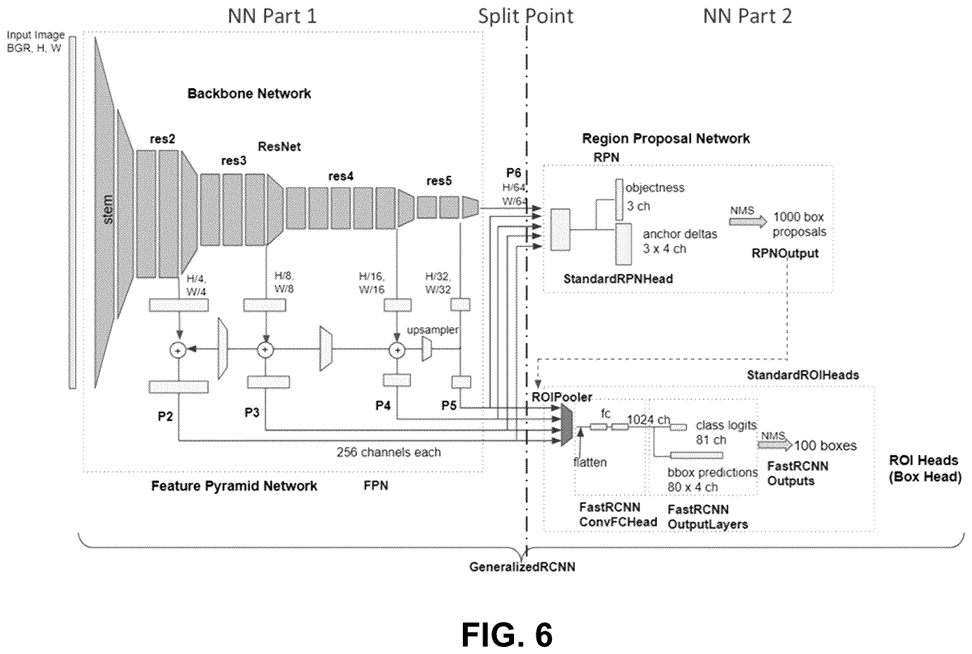

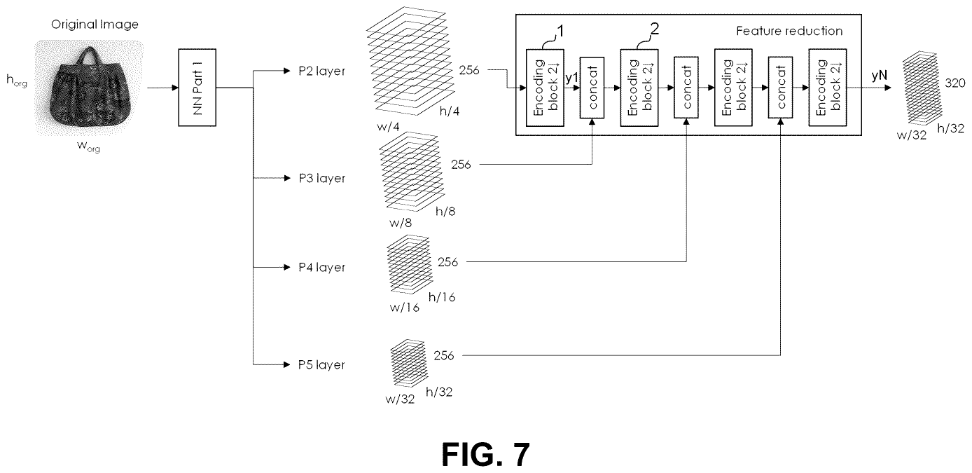

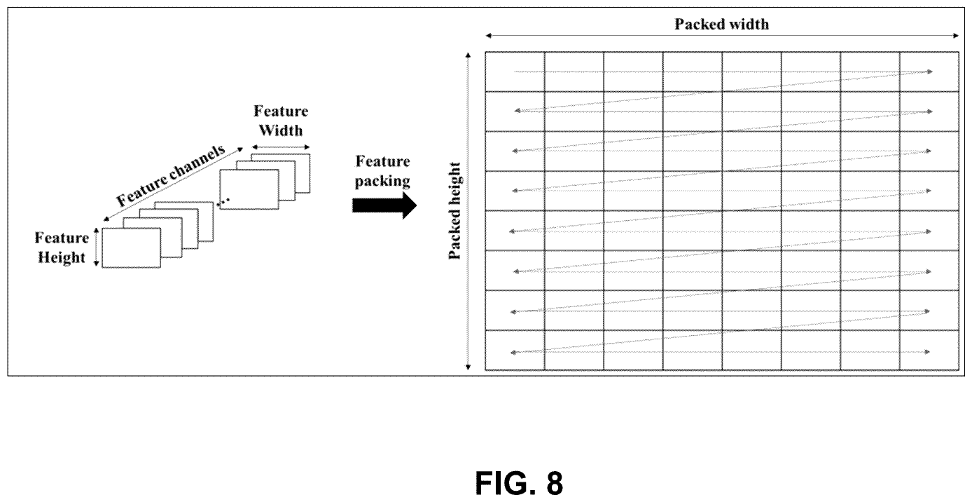

FIG. 5 illustrates an example of decomposing feature data (e.g., as provided by NN task part 1 such as the one illustrated by FIG. 6) in a feature compression scheme (e.g., Feature Coding for Machines or FCM). As shown in FIG. 5, an encoder (e.g., device 1 in the figure) may perform one or more feature reduction, feature conversion and encoding (inner codec) operations. Feature reduction may transform potentially multiple and large tensors or lists of tensors into smaller ones, e.g., by removing redundant or irrelevant information, while preserving meaningful information that is relevant to the overall task as illustrated by FIG. 7. These operations may be performed, for example, using trained neural networks (trained NN). The reduced feature tensors (e.g., as output from by the reduction operation) may be converted into an image or video that can be fed to a 2D image or video codec, e.g., to the inner encoder and inner decoder. To this aim, the reduced feature tensors may be packed (a.k.a. mapped) onto 2D frames as illustrated on FIG. 8, e.g., by the feature conversion process of FIG. 5. The feature conversion process may include other operations, e.g., normalizing and/or quantizing, so that the tensor values are rescaled as unsigned integer values (e.g., in the range of bit-depth supported by the codec, such as, e.g., 8 or 10 bits). Indeed, standard codecs input and output may use integer values. This quantization may be modelled during training of the feature reduction and feature restoration NN, for instance by introducing noise like in end-to-end learned compressors.

In the following, an example of a split neural network for object detection, based on a generalized Region-based Convolutional Neural Network (RCNN) architecture, which is one of the vision models used in MPEG FCM common training and test conditions for evaluating feature compression methods is described. FIG. 6 shows an example of a faster-RCNN model/architecture, which is split into two parts, a backbone network that corresponds to the NN Task Part 1 in FIG. 4, and the rest of the NN, composed of the Region Proposal Network and the ROI heads, which correspond to NN Task Part 2. The split point here involves multiple tensors. More precisely, the backbone may generate feature tensors (e.g., P2, P3, P4, P5, P6) at different spatial resolutions (a.k.a. different scales). The feature tensors may be further processed for an end-task (e.g., object detection and/or segmentation). The set of feature tensors (e.g., {P2, P3, P4, P5}) may thus represent input features on FIG. 5. The feature tensors at the split point may include multiple (e.g., 256) channels for an input image, with different resolutions that may depend on the input resolution (e.g., the input resolution to the model may be different from the input image size due to rescaling and/or padding operations).

FIG. 7 illustrates an example of a neural network architecture for feature reduction. In examples, four feature tensors {P2, P3, P4, P5} output by the NN task part 1 (e.g., of a faster R-CNN and Mask R-CNN) may thus be provided to the feature reduction module shown in FIG. 7. In the example shown in FIG. 7, the set of four feature tensors may be converted into a single feature tensor yN with 320 channels via one or more convolutional layers with learned weights. An original feature tensor (e.g., each original feature tensor) may be padded before they are processed through the one or more convolutional layers. More precisely, a Feature Fusion and Encoding Network (FENet) may be used.

As illustrated on FIG. 7, the intermediate feature tensor with the highest resolution P2 is fed into first Encoding Block (Encoding Block 1) to generate a latent tensor, y1, which has the same resolution with the second highest resolution intermediate feature P3. Following this, y1 and P3 are concatenated and processed through the subsequent Encoding Block 2. This sequential procedure continues until reaching the final latent tensor, yN, with M channels. In the example of FIG. 7, M=320. However, this is only an example. The value of N depends on the type of vision task, e.g., N may be equal to for object detection and segmentation, and N may be equal to 3 for the object tracking. In the example of FIG. 7, the resulting reduced feature has a shape of [320, W/32, H/32]. The encoding blocks are NN that comprise convolutional layers, non-linearities such as ReLU activation function and attention modules. The structure of the encoding blocks may depend on the end-task (e.g., vision task).

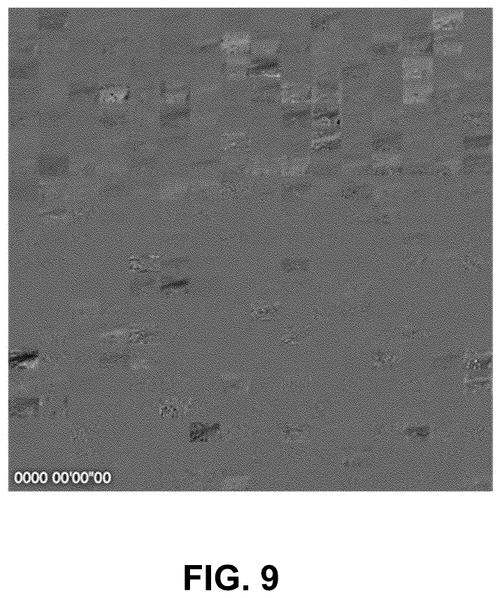

FIG. 8 illustrates schematically the packing onto a 2D image of a tensor composed of a plurality of channels. The channels of the tensor may be organized as a mosaic or said otherwise as tiles of a packed frame. FIG. 9 illustrates an example of packed feature tensors onto a monochrome video frame by the process depicted on FIG. 8. In this example, the intermediate data correspond to a single tensor of dimension C×H×W, where H, W, C denote the Height, Width and number of Channels, respectively. The channels may be organized as tiles of a packed frame. For instance, with C equals 320, the packed frame may correspond to a tiling of 20×16, resulting in a frame of size (20*H)×(16*W) as shown in FIG. 9. The resulting frame may be monochrome (e.g., in a YUV 4:0:0 format for at least some video codecs).

The packed frame may be encoded by an image or video encoder (e.g., inner encoder and inner decoder of FIG. 5), which may result in video data, such as a bitstream. The bitstream may include additional metadata that may specify parameters and/or settings for the reconstruction of the intermediate data (e.g., unpacking, rescaling to the original range of values, restoring the tensors to their original size and shape, etc.).

A decoder (e.g., device 2 of FIG. 5) may perform operations inverse to those of the encoder, as illustrated in FIG. 5. As an example, the decoder may perform one or more decoding (inner decoder), feature conversion and feature restoration operations. For example, the decoder may read a bitstream and the metadata included therein, and feed decoded frames to a feature conversion and restoration process. There may be a sequence of input and reconstructed features, which are computed from some sequence of input frames (i.e., a video). As part of the feature conversion, the decoder may perform de-packing (a.k.a. unpacking) and/or inverse normalization and/or inverse quantization) of one or more tensor channels, for example, based on metadata, e.g., scaling factors and/or geometric arrangement of the tensor channels within the packed frame. As part of the feature restoration, the decoder may take reduced tensors and transform them back to feature tensor or list of tensors of an original size. The feature conversion and/or restoration process may utilize (e.g., benefit from) metadata transmitted within the bitstream to parametrize the process, for example, with respect to an encoder side reduction process that may have been applied for a specific split task model or for specific contents. For instance, the feature restoration process may include learned operations, such as, e.g., learned layer parameters (e.g., weights) of a neural network that may be specific to the content being coded.

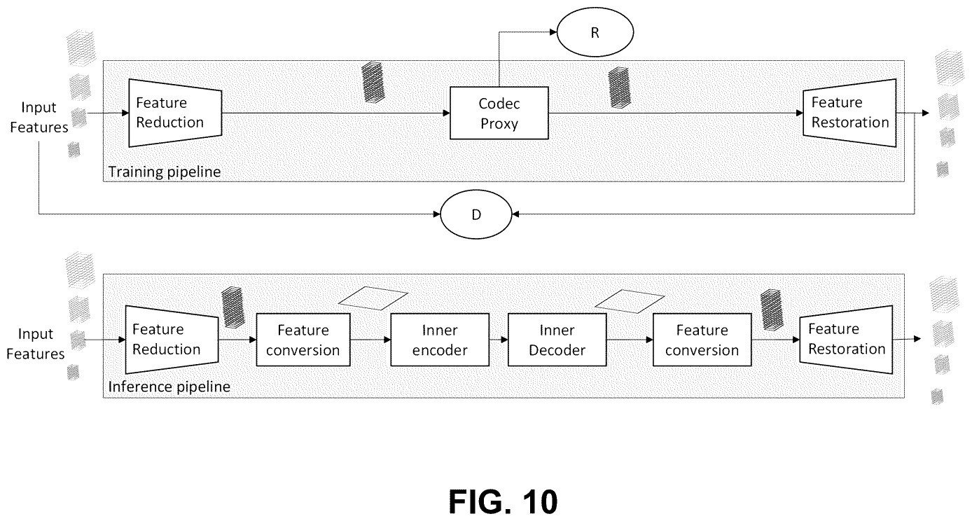

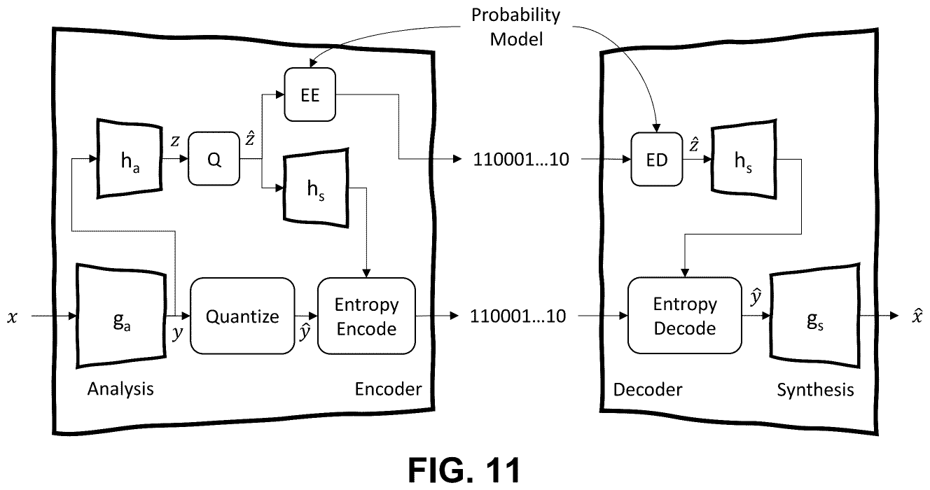

FIGS. 10 and 11 illustrate training and inference pipelines. As mentioned previously, some operations (e.g., reduction and restoration processes) may require learning operations, e.g., learning layer parameters (e.g., weights) of the neural networks (e.g., of the Encoding Blocks on FIG. 7) that may be specific to the content being coded. On FIG. 10, the top row corresponds to the training pipeline and the bottom row to the inference pipeline, i.e., the actual use of the compression framework with a standard 2D codec as inner encoder and decoder. Indeed, Inference refers to the effective usage of the neural networks defined by the learned parameters. Said otherwise, inference applies a trained neural network model and uses it to infer a result. Inference comes after training as it requires a trained neural network model.

The training process (a.k.a. learning process) may use gradient descent. Because derivatives cannot be back-propagated through the standard image codec, the latter may be replaced by a differentiable image codec proxy for the training stage.

FCM compression (e.g., MPEG FCM) solution may include such a training pipeline that uses such a codec proxy (e.g., a differentiable codec proxy), e.g., to train the feature reduction and restoration modules. However, the codec proxy does not consider the actual behavior of a 2D codec. Indeed, as depicted on FIG. 10, the training pipeline does not include the 2D packing operation that would result in a frame like the one shown in FIG. 9. The codec proxy thus estimates a rate R of the encoded bitstream, and outputs an estimate of the actual decoder so that a distortion D can be computed between the restored features (intermediate data) in their original tensor shapes and the input intermediate data to the feature encoder, both metrics being used in the training loss. Indeed, those estimates may be used in a classical compression training loss that can be expressed as: L=R+λ×D. This proxy may be composed of the entropy layers of a sophisticated Learned Image Compression framework, e.g., the one described in the document from He et al. entitled “ELIC: Efficient Learned Image Compression with Unevenly Grouped Space-Channel Contextual Adaptive Coding,” published on Mar. 29, 2022 at CVPR. Like most convolutional end-to-end NN-based image codecs, ELIC includes an analysis module gₐ which transforms an image content x into a latent vector y, and a synthesis module gₛ which transforms a decoded latent vector ŷ back to the pixel domain \hat{x}, as depicted in FIG. 11. The produced latent vector may undergo quantization and entropy coding which relies on a hyperprior model of the probability distributions of the latent variables as well as spatial context modelling. More precisely, FIG. 11 is a block diagram illustrating an example of an architecture of a learned image compression based on an auto-encoder structure augmented with a hyperprior model of the distributions of the latent variables.

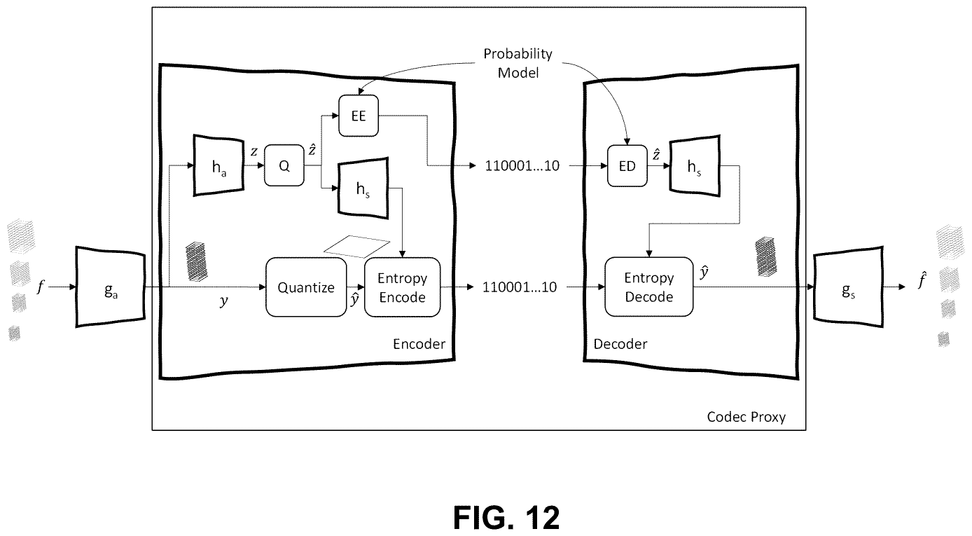

In the current FCM design, gₐ and gₛ as well as the feature conversion are bypassed, i.e., the reduced tensor is directly fed into the ELIC context model, as illustrated on FIG. 10 and FIG. 12. The codec proxy thus takes as input a tensor y and not a 2D frame such as the frame that would be encoded during inference. The ELIC context model (i) operates on channels in C×H×W format, and (ii) uses previously decoded groups of channels to help predict later groups, until all C channels are decoded. This constitutes a first flaw in the design. The goal of the training phase is to train the reduction and restoration modules (e.g., convolutional NN) to work well with the actual image of video codec that will be used at the inference, which operates on the packed (e.g., mapped) 2D content. Therefore, the described proxy does not mimic the conversion of the reduced tensor to 2D images, scaled and quantized to be fed as 8-bit or 10-bit monochrome content to a video codec. For instance, if the channels are packed onto a 2D frame like in FIG. 8, performing the compression with existing standard video codes may introduce compression artefacts at the borders of the tiles as non-continuous texture at tile borders generate high spatial frequencies that may be cut when quantizing the transform domain. Even when the tile borders are aligned with the block partitioning of standard codecs, deblocking filters may be applied, creating compression artifacts around the borders. Since the methodology of (i) does not naturally take this constraint into account. In addition, traditional codecs include intra prediction mechanisms that will not notice correlations between spatially distant channels in the packed 2D frame, whereas as described in (ii), the inter-channel context modeling of ELIC will. Thus, frames that are optimized by an ELIC-based proxy as depicted on FIG. 12 during training may perform more poorly than expected when fed into a more practical traditional codec at inference time.

To compensate for the different compression noise, or artifacts, produced by ELIC and codecs such as H.265/HEVC and H.266/VVC, a secondary training stage may be applied in the current design, e.g., for the feature restoration only. During the secondary training stage, the input of the restoration module corresponds to the reconstructed features, i.e. the output of the actual codec, e.g., H.266/VVC. Thus, there is no back-propagation of gradients beyond the restoration module. However, although this fine-tuning stage of the feature restoration module enables the restoration to account for the actual compression noise introduced by the placed-in codec, it does not enable to fully optimize the system since the computed gradients do not flow all the way back though the reduction module, therefore the structuring of the fused feature tensor still misses the channel packing operation with respect to the inner codec's behavior.

There is thus a need to design an adequate proxy of a 2D codec to further improve the performance of a compression framework involving trained operations, i.e., feature reduction and restoration, while using well deployed but non-differentiable 2D-video codecs at inference time. More precisely, there is a need of an improved FCM framework that comprises feature reduction/restoration, feature conversion and codec proxy which fully consider the actual non-differentiable codec being used when using the split-computing pipeline. A method is thus proposed wherein the proxy introduces the differentiable 2D-frame coding behavior in between the feature reduction and restoration modules during training such that the modules minimize training loss terms while being aware of the compression noise. New feature restoration and reduction methods also described such that the output of the reduction and the input of the restoration consist of tensors (e.g., of 2D frames) that can be directly coded by standard 2D video codecs, e.g. one or three channels, i.e., directly correspond to the content that will be fed to the codec. Compared with the current design, this enables the feature reduction model to transform the input features while estimating all the spatial correlations which are utilized by standard codecs to obtain efficient compression.

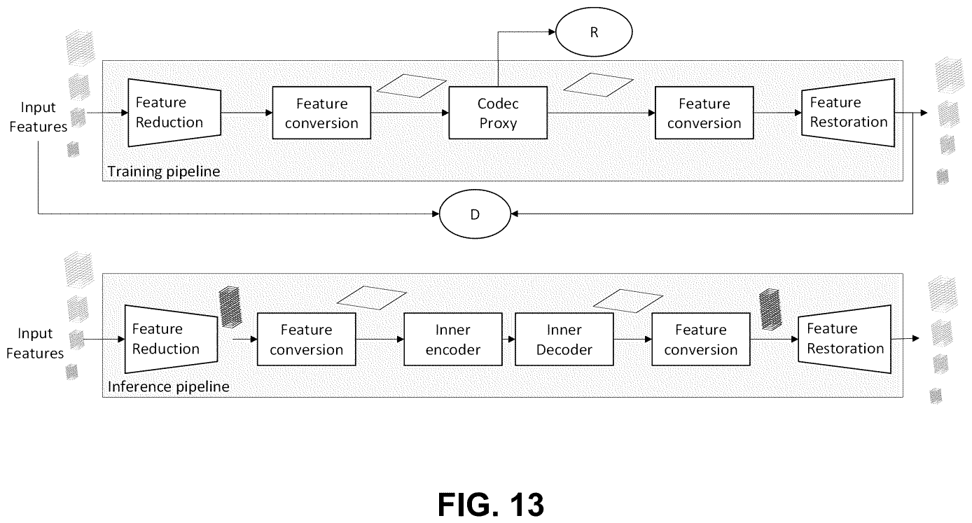

FIG. 13 illustrates training and inference pipelines according to a specific example. The training pipeline is modified compared to FIG. 10 so that the proxy (e.g., codec proxy) introduces the differentiable 2D-frame coding behavior in between the feature reduction and restoration modules during training such that the modules minimize training loss terms while being aware of the compression noise. Said otherwise, the proxy is designed to mimic an image of video codec, i.e., processing 2D frames. At inference stage, the proxy is replaced with non-differentiable codec (i.e., standard video codec). The learned reduction and restoration modules are resilient to actual compression error. The codec proxy is not used in the end design (i.e., during inference), it is only used offline to train the feature reduction and restoration modules. As an example, the feature reduction model shown in FIG. 7 may be kept. However, the channel packing onto 2D frames is now included in the training pipeline.

Any differentiable reshaping function that flattens the features onto 2D frames can be used, like the previously packing illustrated on FIG. 8, or any basic tensor 3D to 2D reshaping function. As an example, the basic tensor reshaping may comprise packing the channel of the reduced tensor line by line in a raster scan order. In this latter case, on the decoder side, the 2D frame (e.g., a decoded frame of the inner decoder) may input a depacking module along with a number indicating the number of channels of the reduced feature tensors. This depacking module reshapes the single channel decoded tensor into a 3D tensor with the size corresponding to the size of the reduced tensor feature to be fed into the feature restoration. The number of samples in both tensors may be (e.g., need) to be equal. This operation may be written as Output=reshape (input, (nb_channels, reduced_channel_height, reduced_channel_width)). This approach (packing line by line) enables a more flexible mapping of intermediate data onto 2D frames. In the above example, a function that computes 2D frame height and width may be used so that the frame dimensions tend toward a square, but any height and width that preserve the number of samples can be envisioned. Note that this simple reshaping is provided as an example, the present principles are not limited to this reshaping, for instance, the reduction and restoration NN layers may be modified so that the output of the reduction already corresponds to 2D frames.

In a variant, the axis of the reduced feature tensor may be permuted, e.g., such that the reshaping produces 2D frames displaying neighboring pixels which correspond to the same location on consecutive channels. This may be more efficient when cross-channel correlations are stronger than spatial raster-scan since local spatial correlations are efficiently removed by means of intra prediction and 2D transforms performed by traditional codecs.

The codec proxy in the example of FIG. 13 may be composed of the entropy layers of a sophisticated Learned Image Compression (LIC) framework, e.g., the ELIC one described on FIG. 11. In this case the analysis module gₐ and the synthesis module gₛ are included in the codec proxy, i.e., the whole LIC framework is used as 2D image (or frame by frame for video) codec proxy.

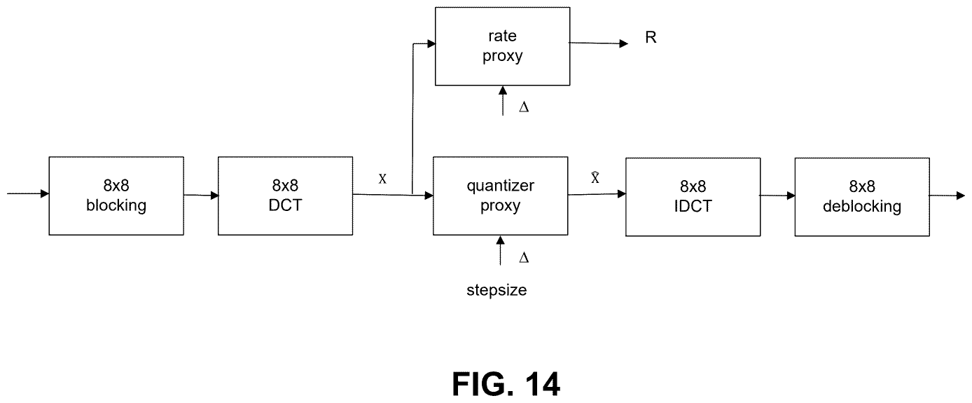

In another example, the current tiling (a.k.a. packing) of feature tensor channels onto video frames is challenged. To that end, the feature reduction and restoration architecture and training are designed in such a way as to transform the input features into frames that are well processed by the inner codec. In the document from Guleryuz et al. entitled “Sandwiched Image Compression: Wrapping Neural Networks Around A Standard Codec” published in 2021 IEEE International Conference on Image Processing (ICIP), Anchorage, AK, USA: IEEE, September 2021, pp. 3757-3761, two neural networks are placed as a pre-encoding and post decoding process, wrapping a traditional standard codec. To train these modules, a differentiable proxy is designed for the training of both pre and post processors, i.e., the “bread slices” of the sandwich. The goal is to transform images or videos into other images or videos that the codec will compress more easily, while the decoded image/video is finally transformed back into the original shape. Similarly, the current design of the FCM codec includes a feature reduction and conversion that maps input features to video frames, whereas inverse conversion and feature restoration transform the decoded content back to the original features. Therefore, in the codec proxy on FIG. 13 may be the one described on FIG. 14, i.e. the one described in the document from Guleryuz et al. The image codec proxy spatially partitions the input channels into 8×8 blocks. In the DCT domain, the blocks X are processed independently, using (1) a “differentiable quantizer” (called a quantizer proxy) to create distorted DCT coefficients (2) a differentiable entropy measure (called a rate proxy) to estimate the bitrate required to represent the distorted coefficients. Both proxies take a nominal quantization stepsize A as an additional input.

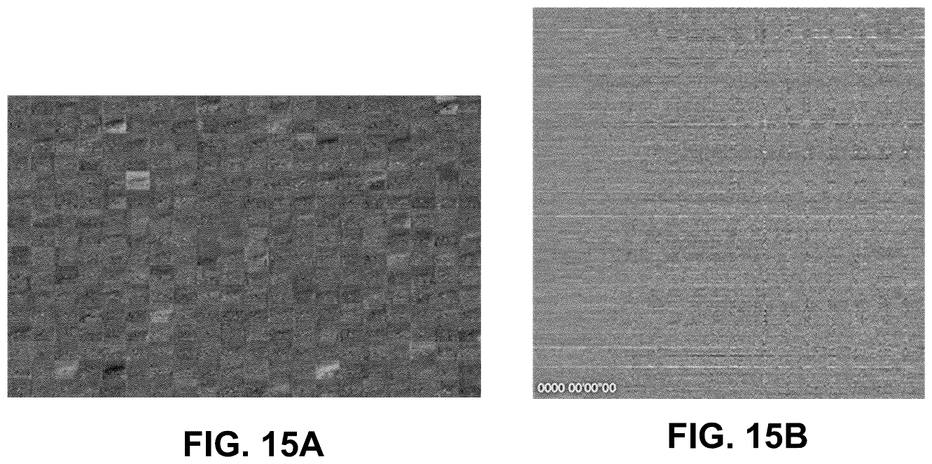

FIG. 15A shows an example of a frame to be fed to the inner codec during inference. This frame is a packed frame (packed with the packing of FIG. 8) obtained with a reduction module (as depicted on FIG. 7) trained as depicted on FIG. 13, i.e. with the packing included in the training pipeline. FIG. 15B shows an example of a frame to be fed to the inner codec during inference. This frame is a packed frame (packed with basic tensor reshaping line by line) obtained with a reduction module (as depicted on FIG. 7) trained as depicted on FIG. 13, i.e. with the packing included in the training pipeline. In this latter example, the reduced feature of size C×H×W=320×20×16 is mapped onto a 320×320 monochrome frame. The feature frame does not reveal visual patterns like in the tiling of FIG. 9, which is similar to the philosophy of the sandwiched compression, where the input of the codec does not need to be visually appealing, as it is a latent variable which only aims at being efficiently compressed by the standard codec, e.g. JPEG in this example.

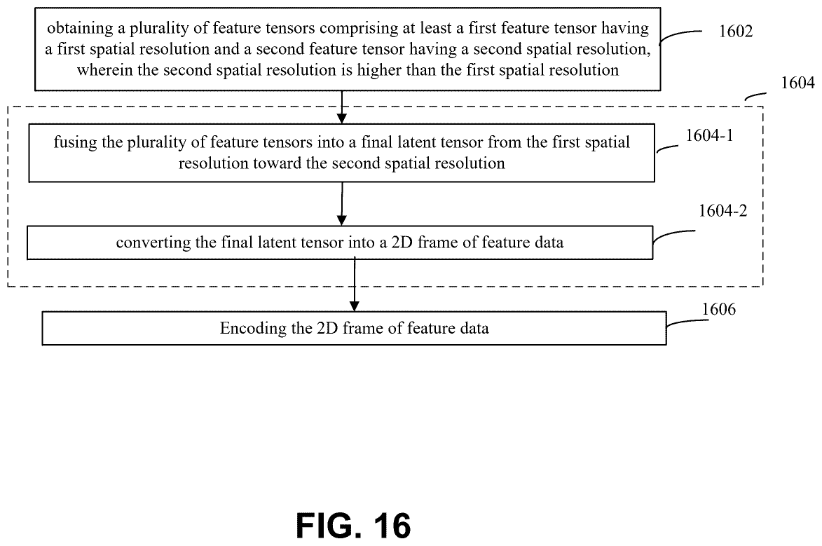

A new model architecture for feature reduction and restoration is also proposed as depicted on FIGS. 16 to 18.

FIG. 16 is a block diagram illustrating an example of an encoding method.

A plurality of feature tensors is obtained (1602). In an example, the plurality of feature tensors comprises at least a first feature tensor having a first spatial resolution and a second feature tensor having a second spatial resolution, wherein the second spatial resolution is higher than the first spatial resolution.

The plurality of feature tensors is reduced (1604) into a two-dimensional frame (2D frame) of feature data. The reducing comprises fusing (1604-1) the plurality of feature tensors into a final latent tensor from the first spatial resolution toward the second spatial resolution.

The reducing comprises further comprises converting (1604-2) the final latent tensor into the 2D frame of feature data. The reduction (1604) may use Encoder Blocks, that may include NN-layers such as convolutional layers, attention modules, and non-linearities such as ReLU. The structure of the Encoder blocks may depend on the end-task (e.g., vision task). Like the other NN blocks (Encoder blocks), the conversion into 2D frame may include convolutions. For instance, 1×1 convolutions enable to collapse the number of channels C of an input tensor to C′ channels with C′<C. Other sizes of kernels can be used, e.g., 3×3. The conversion may comprise a single convolution with output C′=1 or a series of convolutions where the output number of channels is decreased at each sequential convolution, the last convolution outputting a 1 channel tensor. In this example, the conversion into a 2D frame is part of feature reduction. Therefore, the parameters (e.g., NN parameters such as weights) of the conversion may be learned during a training stage, e.g., at the same time as the parameters of the other modules (e.g., of the Encoder Blocks).

The 2D frame of feature data is encoded (1606) in a bitstream.

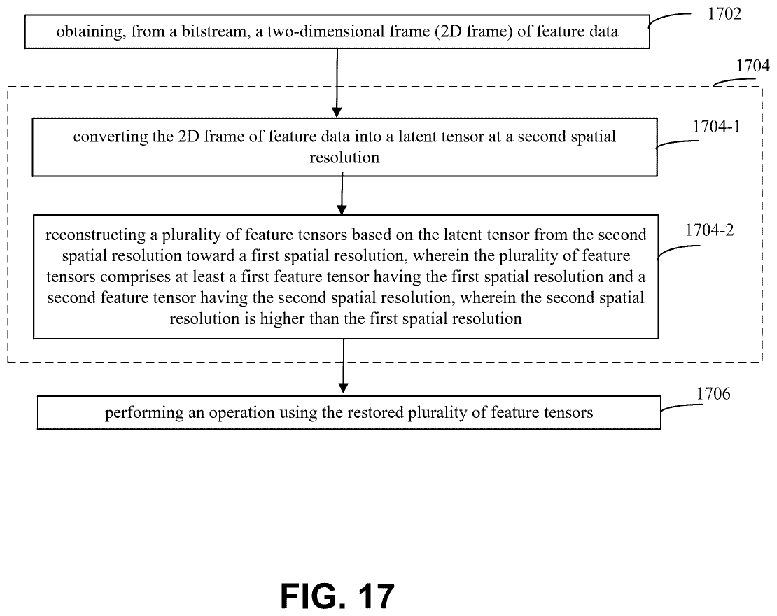

FIG. 17 is a block diagram illustrating an example of an encoding method.

A two-dimensional frame (2D frame) of feature data may be obtained from a bitstream (1702). A plurality of feature tensors may be restored (1704) based on the 2D frame of feature data, wherein the plurality of feature tensors comprises at least a first feature tensor having a first spatial resolution and a second feature tensor having a second spatial resolution, wherein the second spatial resolution is higher than the first spatial resolution.

The restoration comprises converting (1704-1) the 2D frame of feature data into a latent tensor at the second spatial resolution. The restoration further comprises reconstructing (17304-2) the plurality of feature tensors based on the latent tensor from the second spatial resolution toward the first spatial resolution.

The restoration (1704) may use Decoder Blocks, that may include NN-layers such as convolutional layers, attention modules, and non-linearities such as ReLU. Like the other NN blocks (Decoder blocks), the conversion may include convolutions. In this example, the conversion (1704-1) is part of feature restoration. Therefore, the parameters (e.g., NN parameters such as weights) of the conversion may be learned during a training stage, e.g., at the same time as the parameters of the other modules (e.g., of the Decoder Blocks).

An operation (e.g., a vision task) may be performed (1706) using the restored plurality of feature tensors.

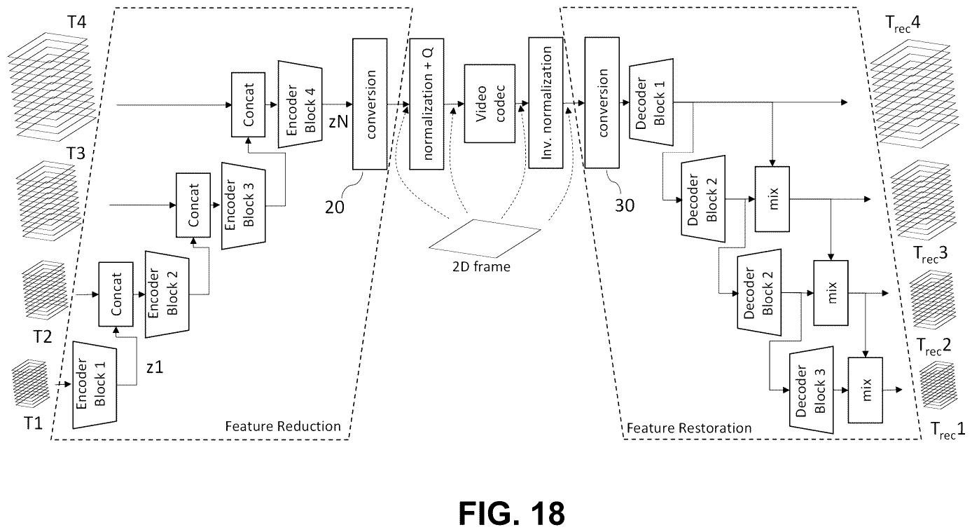

FIG. 18 depicts another example of a reduction and restoration architecture. While illustrated on the same figure, both methods (reduction and restoration) are independent and may be operated in different remote devices. While on FIG. 18, four intermediate feature tensors T1 to T4 are considered, more than 4 or less than 4 intermediate feature tensors may be considered.

The reduction method generates content (e.g., a 2D frame of feature data) that may be directly fed into the codec (e.g., video codec) as input. More precisely, the video codec depicted on FIG. 18 may be split into a video encoder (inner encode, e.g. a VVC encoder) generating a bitstream and a video decoder (inner video decoder, e.g. a VVC decoder) receiving a bitstream. The decoding part of this architecture may be standardized (e.g., by MPEG-FCM), which takes 2D frames as input that are the output of the video codec (e.g., of a 2D standard codec). On the encoder side, the architecture only leaves the normalization and quantization operations between the feature reduction and the codec (e.g. the video codec), i.e. the feature reduction method directly output a 2D frame. The feature reduction and feature restoration include encoder blocks, respectively decoder blocks, that may include NN-layers such as convolutional layers, attention modules, and non-linearities such as ReLU. The structure of the encoding blocks may depend on the end-task (e.g., vision task).

The feature restoration comprises a conversion block 20 that outputs a 1-channel tensor (a.k.a. 2D tensor), i.e., a 2D frame of features, from a multi-channel tensor output by Encoder block 4. The 2D frame may be normalized and/or quantized before being encoded in a bitstream. The normalization and quantization operations rescale tensor values as unsigned integer values in the range of supported bit-depth by the codec (e.g. the video codec), e.g. 8 or 10 bits. The bitstream may be received by a decoder.

At the decoder side, a 2D frame of features is reconstructed (decoded) by the decoder (e.g., decoder part of the video codec) that may go through inverse normalization. The conversion block 30 may take as input the 2D frame of features (possibly after inverse normalization) and outputs a multi-channel tensor to be fed to the decoder block 1 (e.g., common decoder block). Like the other NN blocks (encoder and decoder blocks), the conversion blocks at the encoder and at the decoder may include convolutions. For instance, 1×1 convolutions enable to collapse the number of channels C of an input tensor to C′ channels with C′<C. Other sizes of kernels can be used, e.g., 3×3. A conversion block may comprise a single convolution with output C′=1 or a series of convolutions where the output number of channels is decreased at each sequential convolution, the last convolution outputting a 1 channel tensor.

In the current design of FCM, 2D transpose convolution with larger kernels and stride are used to produce a larger single channel tensor from a lower resolution multi-channel tensor. In the present embodiment, 2D transpose convolution can be used in Encoder Blocks to keep the relevant information prior to video compression.

As illustrated on FIG. 18, in feature reduction, the intermediate feature tensor with the lowest resolution T1 is fed into a first Encoding Block (Encoding Block 1) to generate a latent tensor, z1, which has the same resolution with the second lowest resolution intermediate feature tensor T2. Following this, z1 and T2 are concatenated and processed through the subsequent Encoding Block 2. Going from the lowest resolution toward the highest one makes it possible to keep spatial details.

In an example, concatenation comprises stacking the channels of both tensors. This sequential procedure continues until reaching the final latent tensor, zN, with M channels, e.g., M=320. The value of N depends on the type of task, e.g., N=4 for object detection and segmentation, and N=3 for the object tracking. In this example, the reduction goes from the lowest resolution (T1) up to the highest resolution (T4). The resulting latent tensor zN input the conversion block 20. The resulting reduced feature is 2D frame or said otherwise a 1-channel feature tensor that may be encoded, possibly after normalization and quantization.

As illustrated on FIG. 18, in feature restoration, the output of the conversion block 30 is directed into Decoder Block (Decoder Block 1) to restore the intermediate feature of the highest resolution T4_{rec}. Additionally, to restore the remaining intermediate features (T3_{rec}, T2_{rec}, and T1_{rec}), Decoding blocks corresponding to each intermediate feature are followed by a mixing block. The mixing block enhances the reconstruction quality of the intermediate features by incorporating the output of the corresponding decoding block and the previously restored layer feature as an additional input.

Examples of encoding blocks, decoding block, conversion blocks and mixing block are provided in Tables below. The structure of the encoding blocks, decoding blocks and conversion blocks may depend on the computer vision task such as for example classification, object detection, object tracking, etc. So, the table below are only examples.

In an example, the various encoding blocks may be defined as mentioned in Tables below (with for example M=320, F=256, N=192), where ‘TConv’ means transposed convolution, ↓2 indicates a downsampling by 2 and ↑2 an upsampling by 2.

| Encoding | Encoding |
|---|---|
| Block 1 | Block 2 |
| TConv5 × 5(F, N) ↑2 | TConv5 × 5(F + N, N/2) ↑2 |
| ResBlock(N, N) × 3 | ResBlock(N/2, N/2) × 3 |
| | AttnBlock(N/2) |

| Encoding | Encoding |
|---|---|
| Block 3 | Block 4 |
| TConv5 × 5(F + N/2, N/4) ↑2 | TConv5 × 5(F + N/4, M) ↑2 |
| ResBlock(N/4) × 3 | AttnBlock(M) |

The scaling block 20 may be defined as follows:

Scaling block

Conv5 × 5(M, 1)
ReLU( )

In an example, the various blocks of the feature restoration may be defined as mentioned in Tables below:

| Descaling | Decoding | Decoding |
|---|---|---|
| block | Block 1 | Block 2 |
| Conv5 × 5(1, M) | Conv5 × 5(M, N) ↓2 | Conv5 × 5(M, N/4) ↓2 |
| ReLU( ) | ResBlock(N) × 3 | ResBlock(N/4) × 3 |
| | Conv1 × 1(N, F) | Conv5 × 5(N/4, N) ↓2 |
| | | ResBlock(N) × 3 |
| | | Conv1 × 1(N, F) |

| Decoding | Decoding |
|---|---|
| Block 3 | Block 4 |
| Conv5 × 5(M, N/2) ↓2 | Conv5 × 5(M, N) ↓2 |
| ResBlock(N/2) × 3 | ResBlock(N) × 3 |
| Conv5 × 5(N/2, N) ↓2 | Conv5 × 5(N, N) ↓2 |
| AttnBlock(N) | AttnBlock(N) |
| ResBlock(N) × 3 | ResBlock(N) × 3 |
| Conv5 × 5(N, N) ↓2 | Conv5 × 5(N, N) ↓2 |
| ResBlock(N) × 3 | ResBlock(N) × 3 |
| Conv1 × 1(N, F) | Conv5 × 5(N, N) ↓2 |
| | ResBlock(N) × 3 |
| | Conv1 × 1(N, F) |

The mixing blocks may be defined as follows:

Feature Mixing Block

Conv5 × 5(N, N) ↓2
LeakyReLU( )
Conv3 × 3(2N, N)
LeakyReLU( )

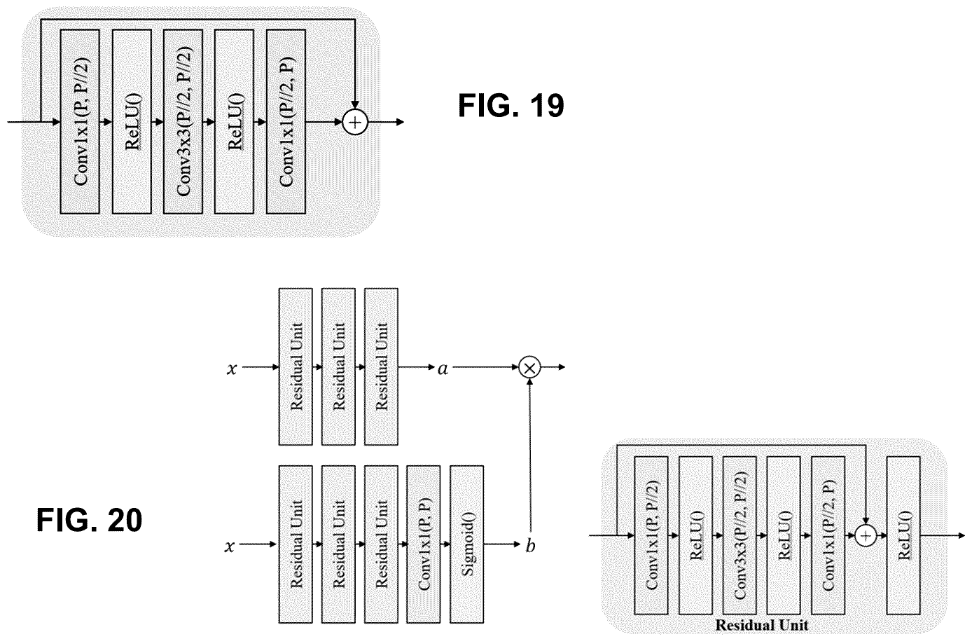

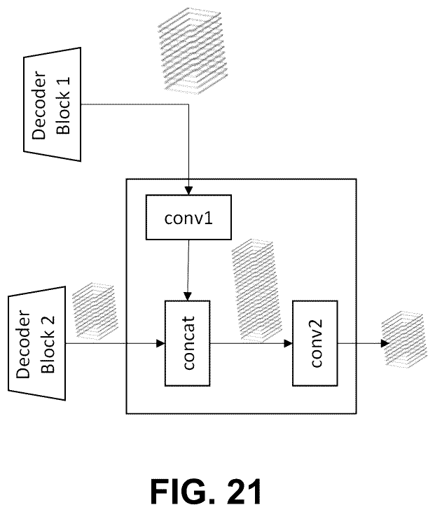

FIG. 19 illustrates details of ResBlock(P,P′). FIG. 20 illustrates details of AttnBlock(P,P′). FIG. 21 illustrates details of a mixing block. ResBlock(P)=ResBlock(P,P) and AttnBlock(P)=AttnBlock(P,P).

This architecture makes it possible for the feature reduction to generate directly 2D frames that will be efficiently compressed by the standard codec. The model, like in the current FCM design, can be scaled and take multiple tensors of different resolution as input.

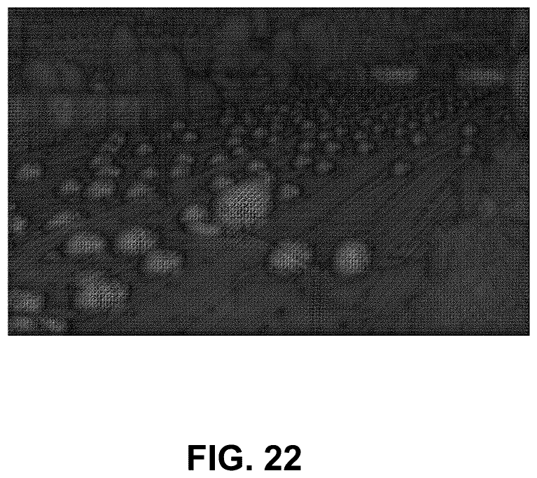

FIG. 22 shows an example of a 2D frame output by the reduction and normalization method depicted on FIG. 18, which can be compared with other packed pictures (e.g., the one on FIG. 9) since FIG. 9, FIG. 15A, FIG. 15B and FIG. 22 show packed pictures resulting from the same input frame, which corresponds to the first picture of the Traffic sequence of the SFU dataset. In this example, the proposed feature reduction is used with a conversion function that includes a transpose convolution with stride of 2, resulting in a frame with height and width equal to the double of the resolution of the largest feature tensor.

In the case of a feature reduction that creates an output of 2D frame with reduced size of features, there is no need for unpacking. In the current specification, the existing unpacking_bypass_flag can be turned to 0 in the feature sequence parameter set which is reproduced below. 2 cases can be distinguished. Either the packing is finally completely removed from the standard specification if the proposed restoration is adopted, i.e., no need for a packing activation flag, or multiple reduction/restoration architecture can be considered at the decoder. In that case, the proposed architecture is activated when unpacking_bypass_flag is true.

| | Descriptor |
|---|---|
| feat_seq_parameter_set_rbsp ( ) { | |
| fsps_feat_seq_parameter_set_id | |
| num_ori_feat_layers | |
| for (i = 0; i <= num_feature_layers; i++) { | |
| ori_feat_wid[i] | |
| ori_feat_hei[i] | |
| num_ori_feat_chan[i] | |
| } | |
| fused_feat_wid | |
| fused_feat_hei | |
| inner_decoding_bypass_flag | |
| if( !inner_decoding_bypass_flag ) { | |
| feat_inner_decoder_info( ) | |
| } | |
| dequant_bypass_flag | |
| unpacking_{—}bypass_{—}flag | |
| feat_restoration_bypass_flag | |
| if( !feat_restoration_bypass_flag ) | |
| feat_restoration_info( ) | |
| } | |
| temporal_upsampling_enable_flag | u(1) |
| restored_feat_refine_flag | u(1) |
| fused_feat_refine_flag | u(1) |
| if (restored_feat_refine_flag ) { | |
| restored_feat_refine_refresh_period | u(8) |
| } | |
| if(fused_feat_refine_flag) { | |
| fused_feat_refine_refresh_period | u(8) |
| } | |
| rbsp_trailing_bits( ) | |
| } | |

Then, the decoding process for feature restoration may be modified such that the proposed restoration method (of FIG. 18) is considered.

In a case where both the default and the new feature restoration model are used, it is proposed to switch to the proposed architecture when unpacking_bypass_flag is true.

Indeed, the current FCM design considers default restoration models that can be loaded depending on a switch symbol as follows (the specifications are reproduced in italic below):

```
if ( FSPS::use_default_restoration_model_flag )
/* The default Feature Restoration model (the DRNet topology and weights) is activated. */
  activatedRestorationTopology = DEFAULT_TOPOLOGY /* DRNet architecture */
  if ( feat_restoration_weight_idx == 0 )
activatedRestorationWeights = DEFAULT_WEIGHTS_0 /* DRNet weights for Detection */
else if ( feat_restoration_weight_idx == 1 )
activatedRestorationWeights = DEFAULT_WEIGHTS_1 /* DRNet weights for Segmentation */
else if ( feat_restoration_weight_idx == 2 )
activatedRestorationWeights = DEFAULT_WEIGHTS_2 /* DRNet weights for Tracking-TVD
*/
else if ( feat_restoration_weight_idx == 3 )
activatedRestorationWeights = DEFAULT_WEIGHTS_3 /* DRNet weights for Tracking-HiEve
*/
```

FSPS denotes that the symbol is part of the feature sequence parameter set, i.e. the high level syntax elements that are valid for the whole video sequence.

The switching to the proposed architecture when unpacking_bypass_flag is true is specified as follows:

```
if ( use_{—}default_{—}restoration_{—}model_{—}flag )
    if (unpacking_{—}bypass_{—}flag)
  activatedRestorationTopology = DEFAULT_{—}2D_{—}INPUT_{—}TOPOLOGY
  /* New architecture
is activated. */
    else
/* The default Feature Restoration model
(the DRNet topology and weights) is activated. */
  activatedRestorationTopology = DEFAULT_{—}3D_{—}TOPOLOGY
  /* DRNet architecture */
```

In another embodiment, the new feature restoration may be signaled. The table below reports the current syntax and the semantics that may be used to signal the parameters of the proposed feature restoration. It can be seen that the NN-Feature-Restoration (nnfr) selection and/or transmission of the weights can be done with several option including signaling via existing indexed decoders, or the use of architecture representations such as MPEG NNC (ISO/IEC 15938-17) bitstream or other ONNX model exchange formats.

The feature restoration model architecture that takes a single channel tensor as input, would be easily detectable when the following syntax points to such a registered restoration model or MPEG-NNC URI.

| | Descriptor |
|---|---|
| fcm_decoder_info( payloadSize ) { | |
| fcm_decoder_info_sei_id | ue(v) |
| set_level_flag | u(1) |
| if( set_level_flag ) | |
| fcm_level | u(8) |
| update_decoder_flag | u(1) |
| if( update_decoder_flag ) { | |
| no_weights_flag | u(1) |
| nnfr_mode_idc | u(6) |
| if( nnfr_mode_idc = = 1 ) { | |
| /* ISO/IEC 15938-17 bitstream */ | |
| while( !byte_aligned( ) ) | |
| nnfr_alignment_zero_bit_a | u(1) |
| for( i = 0; more_data_in_payload( ); i++ ) | |
| nnfr_payload_byte[ i ] | b(8) |
| } | |
| if( nnfr_mode_idc = = 2 ) { | |
| while( !byte_aligned( ) ) | |
| nnfr_alignment_zero_bit_b | u(1) |
| nnfr_tag_uri | st(v) |
| nnfr_uri | st(v) |
| } | |
| if( nnfr_mode_idc = = 3) { | |
| explicit_decoder_compression_idc | u(2) |
| explicit_decoder_format_idc | u(4) |
| explicit_decoder_format_version_idc | ue(v) |
| explicit_decoder_payload_len | ue(v) |
| for( i = 0; i < explicit_decoder_payload_len; i ++ ) | |
| decoder_payload[ i ] | u(8) |
| register_decoder_idc_flag | u(1) |
| if( register_decoder_idc_flag ) | |
| decoder_idc | ue(v) |
| } else { | |
| registered_decoder_idc | UTF-8 |
| | string |
| } | |
| if (!no_weights_flag ) { | |
| update_weights_flag | u(1) |
| if( update_weights_flag ) { | |
| explicit_signal_weights_flag | u(1) |
| if( explicit_signal_weights_flag ) { | |
| explicit_weights_idc | ue(v) |
| explicit_weights_payload_len | ue(v) |
| for( i = 0; i < | |
| explicit_weights_payload_len; i++ ) | |
| weights_payload[ i ] | u(8) |
| } | |
| } | |
| } | |
| } | |

### FCM Decoder Info Semantics:

fcm_decoder_info_sei_id contains an identifying number that may be used to identify an FCM decoder. The value of fcm_id shall be in the range of 0 to 2³²-2, inclusive. Values of fcm_id from 256 to 511, inclusive, and from 2³¹ to 2³²-2, inclusive, are reserved for future use by ITU-T|ISO/IEC. Decoders conforming to this version of this Specification encountering an FCM SEI message with fcm_id in the range of 256 to 511, inclusive, or in the range of 2³¹ to 2³²-2, inclusive, shall ignore the SEI message.

set_level_flag equal to one indicates that the tensor decompression complexity indication is to be signalled in this instance of the FCM decoder info SEI message.

fcm_level signals the complexity indication for any tensor decompressors to be performed in the decoder. The complexity indication provides a worst-case limit on the complexity of any instantiated tensor decompressor. It is a requirement of bitstream conformance that the tensor decompression complexity indication is signalled prior to use of the FCM decoder, e.g., signalled with the first frame of packed tensor data in the bitstream. The following table shows permitted maximum values for complexity aspects for given fcm_level values:

| fcm_level | MAC count | Weight count |
|---|---|---|
| 0 | <5M | <1M |
| 1 | <15M | <5M |
| 2 | <50M | <10M |
| 3-254 | (reserved for | (reserved for |
| | future use) | future use) |
| 255 | | |

update_decoder_flag equal to 1 indicates that the FCM decoder is to be updated, effective from this instance of the FCM decoder info SEI message onwards.

no_weights_flag equal to 1 indicates that the FCM decoder does not include any trained elements (e.g., convolutions) and therefore does not require any weights.

nnfr_mode_idc when equal to 1, indicates that the neural network information is contained in the FCM SEI message, and the neural network information is in the format of an ISO/IEC 15938-17 bitstream. nnfr_mode_idc equal to 2 indicates that the neural network information is identified by the URI indicated by nnfr_uri with the format identified by the tag URI nnfr_tag_uri. nnfr_mode_idc equal to 3 indicates that the FCM decoder architecture is signalled explicitly in this instance of the FCM decoder info SEI message. When equal to zero, this instance of the FCM decoder info SEI message instead references a previously signalled FCM decoder architecture or references an FCM decoder architecture obtained by external means, e.g., a predetermined architecture or an architecture available from a publicly accessible registry. The value of nnfr_mode_idc shall be in the range of 0 to 255, inclusive. Values of 3 to 255, inclusive, for nnfr_mode_idc are reserved for future use by ITU-T|ISO/IEC and shall not be present in bitstreams conforming to this version of this Specification. Decoders conforming to this version of this Specification shall ignore FCM SEI messages with nnfr_mode_idc in the range of 3 to 255, inclusive.

nnfr_alignment_zero_bit_a shall be equal to 0.

nnfr_payload_byte[i] contains the i-th byte of a bitstream conforming to ISO/IEC 15938-17. The byte sequence fcm_payload_byte[i] for all present values of i shall be a complete bitstream that conforms to ISO/IEC 15938-17.

nnfr_alignment_zero_bit_b shall be equal to 0.

nnfr_tag_uri contains a tag URI with syntax and semantics as specified in IETF RFC 4151 identifying the format and associated information about the neural network used as a base FCM Feature restorer or an update relative to the base FCM feature restorer with the same fcm_id value specified by nnfr_uri.

NOTE-nnfr_tag_uri enables uniquely identifying the format of neural network data specified by nnfr_uri without needing a central registration authority. nnfr_uri equal to “tag: iso.org,2023:15938-17” indicates that the neural network data identified by nnfr_uri conforms to ISO/IEC 15938-17.

nnfr_uri contains a URI with syntax and semantics as specified in IETF Internet Standard 66 identifying the neural network used as a base FCM Feature decoder or an update relative to the base FCM Feature decoder with the same fcm_id value.

explicit_signal_decoder_flag equal to 1 indicates that the FCM decoder architecture is signalled explicitly in this instance of the FCM decoder info SEI message. When equal to 0, this instance of the FCM decoder info SEI message instead references a previously signalled FCM decoder architecture or references an FCM decoder architecture obtained by external means, e.g., a predetermined architecture or an architecture available from a publicly accessible registry.

explicit_decoder_compression_idc specifies the compression technique (if any) applied to the payload containing the representation of the FCM decoder architecture, in accordance with the following table:

| explicit_decoder_compression_idc | Compression method |
|---|---|
| 0 | None |
| 1 | DEFLATE |
| 2 | LZMA |
| 3 | Reserved for future use |

explicit_decoder_format_idc specifies the format in which the FCM decoder architecture is encoded, with the following formats supported:

| explicit_decoder_format_idc | Decoder representation format |
|---|---|
| 0 | ONNX |
| 1 | NNEX |
| 2 | Pytorch |
| 3 | Variable-length scheme |
| 4-15 | Reserved for future use |

nnfr_mode_idc drives the way the data will be accessed, i.e., from an NNC bitstream architecture but with the payload of data included in the SEI (mode 1), from a separate NNC bitstream (mode 2), or from an explicit coding of the parameters other than NNC (mode 3).

explicit_decoder_format_version_idc specifies the version of the format in which the FCM decoder architecture is encoded. For each supported format, a separate enumeration of explicit_decoder_format_version_idc values to versions Of the format is specified.

explicit_decoder_payload_len specifies the length of the payload containing the FCM decoder representation in bytes, after application of Compression (if applicable).

decoder_payload[i] specifies the ith byte of the FCM decoder representation.

register_decoder_idc_flag equal to one indicates that the FCM decoder representation signalled in this instance of the FCM decoder info SEI message is to be registered (retained) in the decoder for potential future reference.

decoder_idc specifies an index value for addressing the FCM decoder representation in a registry of retained FCM decoder architectures.

explicit_signal_weights_flag equal to one indicates that weights associated with the signalled FCM decoder representation are included in this instance of the FCM decoder info SEI message.

explicit_weights_idc specifies an index for the weights signalled in this instance of the FCM decoder info SEI message.

explicit_weights_payload_len specifies the length of the weights payload in the FCM decoder info SEI message.

weights_payload[i] specifies the ith byte of the weights payload in the FCM decoder info SEI Message.

register_weights_idc_flag equal to one specifies that the weights signalled in this instance of the FCM decoder info SEI message are stored in the FCM decoder for potential future reference.

registered_decoder_idc specifies an index to address an FCM decoder representation that is either known to the decoder by external means or was registered with the FCM decoder in an earlier instance of the FCM decoder info SEI Message.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. A bitstream that includes one or more of the described syntax elements, or variations thereof, whether transmitted, stored, or otherwise made available.
iii. Creating, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. hypertext transfer protocol (HTTP) live Streaming (HLS) manifest transmitted over HTTP.
iii. dynamic adaptive streaming over HTTP (DASH) media presentation description (MPD) descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter is used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), a bit savings is thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. An encoding method, comprising:
obtaining a plurality of feature tensors comprising at least a first feature tensor having a first spatial resolution and a second feature tensor having a second spatial resolution, wherein the second spatial resolution is higher than the first spatial resolution;
reducing the plurality of feature tensors into a two-dimensional frame (2D frame) of feature data; and
encoding the 2D frame of feature data in a bitstream;
wherein reducing the plurality of feature tensors into a two-dimensional frame (2D frame) of feature data comprises:
fusing the plurality of feature tensors into a final latent tensor from the first spatial resolution toward the second spatial resolution; and
converting the final latent tensor into the 2D frame of feature data.

2. The method of claim 1, wherein fusing the plurality of feature tensors into a final latent tensor from the first spatial resolution toward the second spatial resolution comprises:
encoding the first feature tensor to obtain a first latent tensor having the second spatial resolution;
concatenating the first latent tensor with the second feature tensor to obtain a second latent tensor; and
encoding the second latent tensor to obtain the final latent tensor.

3. The method of claim 2, wherein each encoding operation comprises using a learned neural network comprising a combination of convolutional blocks, attention blocks, and non-linearities.

4. The method of claim 1, wherein converting the final latent tensor into the 2D frame comprises using a learned neural network comprising at least one convolutional block and one non-linearity.

5. The method of claim 3, wherein at least one learned neural network is obtained during a training session using a codec proxy taking 2D frames of feature data as input.

6. A decoding method, comprising:
obtaining, from a bitstream, a two-dimensional frame (2D frame) of feature data;
restoring a plurality of feature tensors based on the 2D frame of feature data, wherein the plurality of feature tensors comprises at least a first feature tensor having a first spatial resolution and a second feature tensor having a second spatial resolution, wherein the second spatial resolution is higher than the first spatial resolution; and
performing an operation using the restored plurality of feature tensors;
wherein restoring the plurality of feature tensors based on the 2D frame of feature data comprises:
converting the 2D frame of feature data into a latent tensor at the second spatial resolution; and
reconstructing the plurality of feature tensors based on the latent tensor from the second spatial resolution toward the first spatial resolution.

7. The method of claim 6, wherein restoring the plurality of feature tensors based on the 2D frame of feature data comprises:
decoding the latent tensor to obtain a first restored feature tensor having the second spatial resolution;
decoding the first restored feature tensor to obtain an intermediate latent tensor having the first spatial resolution; and
mixing the intermediate latent tensor having the first spatial resolution with the first restored feature tensor to obtain a restored feature tensor at the first spatial resolution.

8. The method of claim 7, wherein each decoding operation comprises using a learned neural network comprising a combination of convolutional blocks, attention blocks, and non-linearities.

9. The method of claim 6, wherein converting the 2D frame of feature data into a single scale feature tensor at the second spatial resolution comprises using a learned neural network comprising at least one convolutional block and one non-linearity.

10. The method of claim 7, wherein mixing the intermediate latent tensor at the first spatial resolution with the restored feature tensor at the second spatial resolution comprises using a learned neural network comprising a combination of convolutional blocks, attention blocks, and non-linearities.

11. The method of claim 8, wherein at least one learned neural network is obtained during a training session using a codec proxy taking 2D frames of feature data as input.

12. An encoding apparatus comprising one or more processors and at least one memory coupled to said one or more processors, wherein said one or more processors are configured to perform:
obtaining a plurality of feature tensors comprising at least a first feature tensor having a first spatial resolution and a second feature tensor having a second spatial resolution, wherein the second spatial resolution is higher than the first spatial resolution;
reducing the plurality of feature tensors into a two-dimensional frame (2D frame) of feature data; and
encoding the 2D frame of feature data in a bitstream;
wherein reducing the plurality of feature tensors into a two-dimensional frame (2D frame) of feature data comprises:
fusing the plurality of feature tensors into a final latent tensor from the first spatial resolution toward the second spatial resolution; and
converting the final latent tensor into the 2D frame of feature data.

13. A decoding apparatus comprising one or more processors and at least one memory coupled to said one or more processors, wherein said one or more processors are configured to perform:
obtaining, from a bitstream, a two-dimensional frame (2D frame) of feature data;
restoring a plurality of feature tensors based on the 2D frame of feature data, wherein the plurality of feature tensors comprises at least a first feature tensor having a first spatial resolution and a second feature tensor having a second spatial resolution, wherein the second spatial resolution is higher than the first spatial resolution; and
performing an operation using the restored plurality of feature tensors;
wherein restoring the plurality of feature tensors based on the 2D frame of feature data comprises:
converting the 2D frame of feature data into a latent tensor at the second spatial resolution; and
reconstructing the plurality of feature tensors based on the latent tensor from the second spatial resolution toward the first spatial resolution.

14-15. (canceled)

16. The encoding apparatus of claim 12, wherein fusing the plurality of feature tensors into a final latent tensor from the first spatial resolution toward the second spatial resolution comprises:
encoding the first feature tensor to obtain a first latent tensor having the second spatial resolution;
concatenating the first latent tensor with the second feature tensor to obtain a second latent tensor; and
encoding the second latent tensor to obtain the final latent tensor.

17. The encoding apparatus of claim 16, wherein each encoding operation comprises using a learned neural network comprising a combination of convolutional blocks, attention blocks, and non-linearities.

18. The encoding apparatus of claim 17, wherein converting the final latent tensor into the 2D frame comprises using a learned neural network comprising at least one convolutional block and one non-linearity.

19. The decoding apparatus of claim 13, wherein restoring the plurality of feature tensors based on the 2D frame of feature data comprises:
decoding the latent tensor to obtain a first restored feature tensor having the second spatial resolution;
decoding the first restored feature tensor to obtain an intermediate latent tensor having the first spatial resolution; and
mixing the intermediate latent tensor having the first spatial resolution with the first restored feature tensor to obtain a restored feature tensor at the first spatial resolution.

20. The decoding apparatus of claim 19, wherein each decoding operation comprises using a learned neural network comprising a combination of convolutional blocks, attention blocks, and non-linearities.

21. The decoding apparatus of claim 13, wherein converting the 2D frame of feature data into a single scale feature tensor at the second spatial resolution comprises using a learned neural network comprising at least one convolutional block and one non-linearity.

22. The decoding apparatus of claim 19, wherein mixing the intermediate latent tensor at the first spatial resolution with the restored feature tensor at the second spatial resolution comprises using a learned neural network comprising a combination of convolutional blocks, attention blocks, and non-linearities.
